(19) United States
(12) Patent Application Publication
(10) Pub. No.: US 2025/0347512 A1
(43) Pub. Date: Nov. 13, 2025

(54) SURFACE HEIGHT MEASUREMENTS USING A SCANNING PATH FOLLOWING A TOOLPATH AND METHODS THEREOF

(71) Applicant: Additive Technologies, LLC dba ADDiTEC, Palm City, FL (US)

(72) Inventors: Chu-heng Liu, Penfield, NY (US); Paul J. McConville, Webster, NY (US); Patrick Y. Maeda, San Jose, CA (US)

(73) Assignee: Additive Technologies, LLC dba ADDiTEC, Palm City, FL (US)

(21) Appl. No.: 18/659,124

(22) Filed: May 9, 2024

(51) Int. Cl. G01B 11/24; B22F 10/22; B22F 10/30; B33Y 50/00; G01B 11/06

(52) U.S. Cl. CPC G01B 11/24; B22F 10/22; B22F 10/30; B33Y 50/00; G01B 11/0608

(57) ABSTRACT

A system for measuring surface heights during three-dimensional fabrication is disclosed, including a point z-height sensor configured to measure a position of a tool fabrication spot on a surface being printed, an attachment mechanism for attaching the point z-height sensor to a tool assembly such that movement of the point z-height sensor remains in sync with a toolpath that may include movement of the tool assembly, and a control system configured to optimize a scan path of the tool based on measured height data and movement of the tool assembly. Implementations of system for measuring surface heights during three-dimensional fabrication may include where the tool is a printhead. Methods for measuring z-height during three-dimensional fabrication using a z-height point sensor and measuring surface height in a three-dimensional printing process are also disclosed.

### TECHNICAL FIELD

The present teachings relate generally to a measurement method for fabrication methods and, more particularly, to a measurement method for processing incorporating toolpaths into fabrication methods.

### BACKGROUND

Additive manufacturing printing systems and fabrication methods involving the use of toolpaths can be used to create three-dimensional parts, by ejecting small drops of liquid metals or molten plastics, when a firing pulse is applied. These and other means of fabricating three-dimensional parts can be used to create parts from aluminum alloy and other materials by ejecting a series of drops which bond together to form a continuous part. Also, other subtractive manufacturing techniques can also be used to create or finish three-dimensional parts.

To build a part of high quality, precise layer height control must be maintained. In some fabrication systems, the use of a three-dimensional camera system and control loop can be used to compensate for any z-height errors during the fabrication process. Such cameras can be expensive and slow, costing tens of thousands of dollars and sometimes requiring up to five minutes per layer for adequate scanning.

Therefore, it is desirable to utilize alternative measurement methods during three-dimensional part fabrication to increase processing time and reduce cost.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A system for measuring surface heights during three-dimensional fabrication is disclosed. The system includes a point z-height sensor configured to measure a position of a tool fabrication spot on a surface being printed, an attachment mechanism for attaching the point z-height sensor to a tool assembly such that movement of the point z-height sensor remains in sync with a toolpath that may include movement of the tool assembly, and a control system configured to optimize a scan path of the tool based on measured height data and movement of the tool assembly. Implementations of system for measuring surface heights during three-dimensional fabrication may include where the tool is a printhead. The point z-height sensor can be a laser triangulation sensor, optionally configured at a non-normal incidence angle. The system may include a control loop for compensating for any z-height errors during a fabrication process based on the measured height data. The attachment mechanism is configured to maintain an offset distance between the tool fabrication spot and a z-height sensor measurement spot. The system may include a dynamic adjustment mechanism for changing a position of the z-height sensor measurement spot relative to the tool fabrication spot. The point z-height sensor and the additional point z-height sensor are arranged in a grid pattern perpendicular to the toolpath for increasing x-y resolution. The system may include a low-pass filter for smoothing out any noise in the measured height data.

A method for measuring z-height during three-dimensional fabrication using a z-height point sensor is disclosed, including moving a z-height point sensor attached to a tool assembly in synchronization with a toolpath may include tool assembly movement to follow a measurement scanning path, measuring a position of a fabrication spot with the z-height point sensor using laser triangulation, determining an offset distance between the fabrication spot and a measurement spot of the z-height point sensor, producing a combined tool-scan-path by co-optimizing the toolpath and measurement scanning path to simulate a condition where the offset is non-zero, and generating a three-dimensional profile by scanning a top surface of a fabricated layer. Implementations of the method may include adjusting the offset distance between the fabrication spot and a measurement spot of the z-height point sensor of the point z-height sensor. The method may include scanning with an additional z-height point sensor to increase scanning resolution. The additional z-height point sensor scans in a direction perpendicular to the toolpath. The method may include filtering data from the point z-height sensor with a low-pass filter. The method may include adjusting the offset position of the point z-height sensor during a fabrication operation. The point z-height sensor is mounted on a movable platform configured to be adjusted to compensate for variations in a fabrication process. The deviations can be identified by comparing the generated three-dimensional profile with a reference profile stored in memory. Implementations of the described techniques may include hardware, a method or process, or computer software on a computer-accessible medium.

A method for measuring surface height in a three-dimensional printing process is disclosed and includes measuring the height and position of an ejected drop of printing material as it lands on a substrate or portion of a three-dimensional part using a point z-height sensor after the drop of printing material is ejected from an ejector nozzle, moving a position of the point z-height sensor in synchronicity with movement of the ejector nozzle, adjusting an offset position between the point z-height sensor and the ejector nozzle based on variations of a measured position as compared to a reference position, and generating a three-dimensional profile by scanning a top surface of a printed layer with the point z-height sensor. Implementations of the method may include attaching the point z-height sensor to a printhead assembly, following a toolpath used for part building by the ejector nozzle with the z-height scanning path, and filtering data from the point z-height sensor with a low-pass filter.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-1C are a schematic of an exemplary tool path, a schematic of a multiple tool assembly, and a schematic of an exemplary tool path involving multiple tools, in accordance with the present disclosure.

FIG. 2 is a schematic of a laser sensing system, in accordance with the present disclosure.

FIGS. 3A-3E is a series of schematics demonstrating a method of measuring the results of a toolpath implementation using a makeup scan path, in accordance with the present disclosure.

FIGS. 4A-4C is a series of schematics demonstrating a method of measuring the results of a toolpath implementation using an extended toolpath, in accordance with the present disclosure.

FIG. 5 is a side-view schematic showing a toolpath measurement method using an angled laser measurement device, in accordance with the present disclosure.

FIG. 6 shows a method of measuring a toolpath with an offset measurement arrangement in a single direction toolpath, in accordance with the present disclosure.

FIG. 7 shows a method of measuring a toolpath with an offset measurement arrangement in a bidirectional toolpath, in accordance with the present disclosure.

FIG. 8 shows a method of measuring a toolpath with an offset measurement arrangement in a single direction toolpath with sweeping in a second direction, in accordance with the present disclosure.

FIG. 9 depicts a series of plots describing a practical arrangement and orientation of a toolpath measurement system and method, in accordance with the present disclosure.

FIG. 10 depicts a diagram of a restored sampling procedure, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The system and method of the present disclosure provide a point z-height sensor to replace the 3D camera as a line sensor with one pass scanning, resulting in significant efficiency and cost-down potential as compared to printing or tool fabrication systems utilizing 3D cameras. In examples, the z-height scanning will follow most of the toolpath or the entire toolpath that is used for part building. Very little or no extra time would be needed to obtain the z-height data. When the printer or fabrication system finishes a layer, the point z-height sensor will also finish the scanning of the top surface, enabling the generation of a three-dimensional (3D) image or surface profile. In exemplary systems and methods, the point z-height sensor moves in-sync with the fabrication tool or printhead. For example, a z-height sensor can be attached to a printhead assembly.

A primary enabler of this invention is the use of a small offset distance between the drop landing spot in the case of a three-dimensional drop-on-demand printer, or tool working location, and the z-height sensor measurement spot. In a simple case where the offset is zero, or the two spots coincide, the scanning path would be identical to the toolpath. All positions along the toolpath can be scanned and mapped in 3D, to create a surface profile or image. In the cases of small offsets, where the offset is non-zero, various co-optimizations of toolpath and scanning path can be implemented to produce a combined tool-scan-path. When the offset between a fabrication tool position and measurement position is small, most of the two paths should overlap and very little extra travel area or time would be needed for the tool-scan-path compared to build toolpath alone. In examples, multiple point sensors can be used to increase the x-y spatial resolution in a direction perpendicular to the toolpath/scanning path. An additional z-height point sensor can also provide flexibility in measuring ahead of or after a tool fabrication operation, and scan in multiple directions or orientations relative to a fabrication tool. Various optimized tool-scan-paths can be used and will be described in greater detail here. In particular, scanning paths configurations for challenging situations such as bi-directional printing, toolpaths at different angles, multiple sensors, or multiple offset adjustments can be used to overcome these challenges.

The point z-height sensor of the present disclosure serves as a low-cost alternative to the expensive and slow 3D camera system currently used in known metal jetting three-dimensional printers for height measurement during part building. The sensor, which uses laser triangulation techniques, measures the position of the drop landing spot by detecting the distance between the sensor and an ejected liquid aluminum alloy droplet. This method allows for a significant cost-down potential compared to using a 3D camera system while still providing accurate height measurement data. While examples directed towards 3D printing systems will be disclosed, other fabrication systems including directed energy deposition (DED) 3D printing, fused deposition modeling (FDM) 3D printing, machining, and other fabrication processes utilizing predetermined toolpaths can be used in conjunction with the present methods and systems.

The use of a small offset distance between the drop landing spot and the z-height sensor measurement spot can enable the scanning path to follow most of the toolpath or even the entire toolpath used for part building, with very little extra time needed to obtain the z-height data. This results in a more efficient process that reduces the overall printing time while maintaining high quality and precision layer heights. The point z-height sensor can be attached to the printhead assembly in various ways, such as being integrated into the printhead itself or mounted on a separate component that moves in sync with the printhead. This has advantages in terms of performance because it allows for more accurate and consistent measurement of the drop landing spot. When the offset is zero, the scanning path is identical to the toolpath, and all positions along the toolpath can be scanned and mapped in 3D. In cases of small offsets, most of the two paths should overlap, and very little extra travel area or time is needed for the tool-scan-path compared to building the toolpath alone.

In addition to optimization of the tool-scan-path for challenging situations such as bi-directional printing or toolpaths at different angles, multiple sensors can be used to increase X-Y resolution in the direction perpendicular to the toolpath/scanning path. Alternatively, offset adjustments can be made to ensure that the scanning path follows the toolpath correctly in all situations. Advantages of systems and methods using point z-height sensors for height measurement has several advantages over traditional 3D camera systems. It allows for real-time monitoring of the build process, ensuring part quality and reducing the need for post-processing or inspection. Additionally, it eliminates the need for a separate imaging/scan step, resulting in faster printing times with minimal delay between layers.

Co-optimizing the toolpath and scanning path is useful for achieving an efficient and accurate z-height measurement system with a point z-height sensor, as proposed in this disclosure. The toolpath is the path that the printhead or other machining tool follows during printing or fabrication, while the scanning path is the path that the z-height sensor follows to measure the height of each layer. By co-optimizing these two paths, it can serve to minimize extra travel time and ensure sufficient overlap between the toolpath and scanning path.

An initial step in co-optimizing the toolpath and scanning path is to consider factors such as print or fabrication speed, part complexity, and desired resolution and accuracy of the resulting scan. For example, if the part has many intricate details or is being fabricated at a high speed, it may be useful to increase the overlap between the toolpath and scanning path to ensure more accurate z-height measurements. Alternatively, if fabrication speed is of primary concern, the overlap can be reduced to focus on minimizing extra travel time.

Another consideration when co-optimizing the toolpath and scanning path is the position of the z-height sensor relative to the drop landing spot, or tool fabrication location. Since a key enabler of the method and system of this disclosure is the small offset distance between the drop landing spot and the z-height sensor measurement spot, the position of the z-height sensor can be adjusted to ensure that it measures the correct height for each layer. For example, if the toolpath changes direction, the scanning point will remain the same in terms of x-y coordinates but may switch in terms of printing (drop)-measurement (scan) sequence. In this case, the offset can be adjusted according to the tool-scan-path direction to ensure that the z-height sensor measures the correct height for each layer.

Multiple point sensors can be used to achieve maximum efficiency and accuracy, by effectively increasing X-Y resolution in a direction perpendicular to the toolpath/scanning path. By arranging the sensors in a grid pattern and synchronizing them with the printhead, more data points can be collected to improve the resolution and accuracy of the height measurements. This allows for real-time adjustments to a print process or toolpath fabrication execution based on the measured z-height, ensuring part quality throughout the printing process. Fabrication and measuring the height of at least one component can be done simultaneously.

In the present disclosure, a small offset distance between the drop landing spot and the height sensor measurement spot enables the optimization of measurement scanning path with the tool fabrication path. When the offset is zero (the measurement and fabrication spots coincide), the scanning path is identical to the toolpath. All positions along the toolpath will be scanned and mapped in 3D as the tool path is executed. In cases of small offsets, various co-optimizations of toolpath and scanning path can be implemented to produce a combined tool-scan-path. When the offset is small, most of the two paths should overlap, and very little extra travel (time) is needed for the tool-scan-path compared to building the toolpath alone. In some examples, multiple point sensors can be used to increase X-Y resolution in a direction perpendicular to the toolpath/scanning path. Multiple sensors or offset adjustments can be used to overcome these challenges arising from the use of various optimized tool-scan-paths will be proposed, such as bi-directional printing or toolpath at different angles. For convenient image processing, a set of parallel scan lines can be used. The perimeter toolpath could be skipped for scanning while extending the infill toolpath slightly beyond the perimeter, where there is a presence of some non-jetting segments (or other tooling) at the beginning and end of each straight segment and some extra scan lines at both ends) to form a set of parallel tool-scan-paths that will cover the entire cross section of a part being fabricated.

Examples of permutations of the measurement method can include zero offset, finite offset, adjusting the offset position, using multiple scanning devise, and using multiple point sensors. These are described herein within the context of a drop ejecting three-dimensional printer, but it should be understood that other tool fabrication examples can be utilized. For a zero offset, or offset=0, the z-height sensor measures a drop landing spot. In this case, the scan path can follow the toolpath exactly. Measurement can be taken before or after the drop is landed. For high-speed printing, data just before the next drop may be more stable. Data before and after the drop measure the height of the previous layer and the current layer. This information can be used for various process control purposes, such as adjusting parameters of a printing process during a build, or for displaying part integrity. Other applications include error or defect detection and mitigation. In particular, if the data or image deviates significantly from the model, a compensation or error correction method can be applied by adjusting the mass deposition rate around the error spot during the printing of the next layers. Finite offset, used in bidirectional printing having a bidirectional toolpath includes where a toolpath switches direction, and the scan point with respect to the drop landing spot remains the same in x-y space, but can potentially switch in terms of printing (drop)-measurement (scan) sequence. Assuming that the offset is along the direction of the path, in one direction, the scan measures the current layer while the drop comes ahead of it. In the other direction, the scan measures the previous layer. When adjusting the offset positions, a small rotation of the position of the scanning spot can be implemented with respect to the drop spot. This will provide the capability to change the offset. Therefore, the correct offset can always be obtained when the tool-scan-path changes in any directions, even during the printing of the perimeters of a three-dimensional part. With multiple scanning devices, the system can include multiple point scanning devices arranged to be perpendicular to the tool path and measurement path such that multiple lines can be scanned with a single travel. This is particularly useful to increase XY resolution in a direction that is perpendicular to the scan path.

The use of multiple point sensors offers several advantages over traditional single-point sensors. Firstly, it increases the number of data points collected, providing a more accurate representation of the surface height. This is particularly functional in cases where small variations in height exist between different points on the part surface. By using multiple sensors, these variations can be detected and compensated for during the printing process, resulting in a higher quality part with improved dimensional accuracy. Additional advantages of using multiple point sensors include the allowance for better control over the printhead assembly. By adjusting the position of the sensors relative to the drop landing spot, the offset can be adjusted according to the tool-scan-path direction. This enables the sensor to align with either the current or previous layer depending on the printing direction, ensuring that the height measurements are accurate and consistent.

The use of multiple point sensors also allows for dynamic adjustments during the printing process. Variations in the printhead assembly or other factors can cause changes in the z-height measurement, which may require adjustments to be made in real-time. By using multiple sensors, these variations can be detected and compensated for quickly, ensuring that the part quality is maintained throughout the printing process.

In addition to the benefits mentioned above, the use of multiple point sensors also allows for a more convenient image processing method. By arranging the sensors in a grid pattern, parallel scan lines can be used to cover the whole cross-section of the part. This reduces the need for perimeter toolpath scanning and simplifies the overall process.

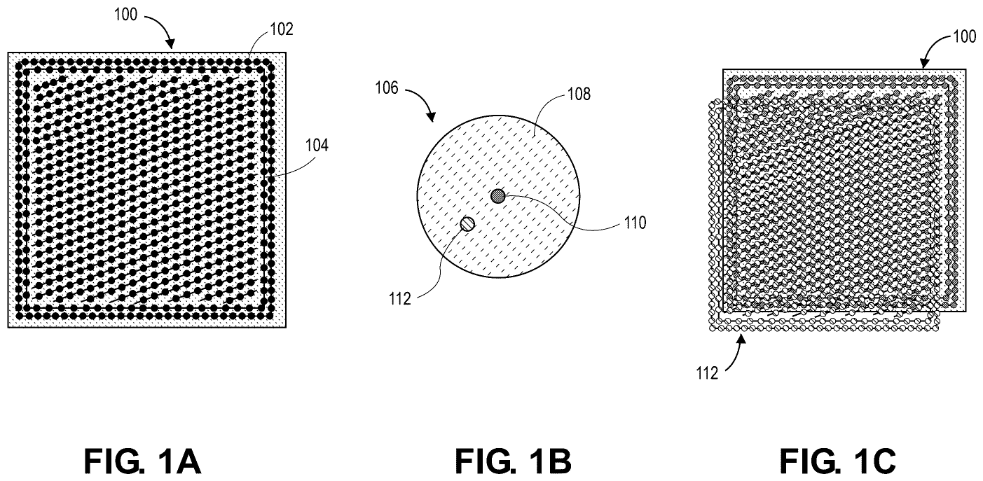

FIGS. 1A-1C are a schematic of an exemplary tool path, a schematic of a multiple tool assembly, and a schematic of an exemplary tool path involving multiple tools, in accordance with the present disclosure. In FIG. 1A, a fabrication toolpath 100 is shown, which in this case can represent a three-dimensional printer, indicating drop locations 102 or tool locations in a case of other fabrication processes along with toolpath lines 104. FIG. 1B is a top view schematic of tool assembly 106, which includes a tool head 108, a tool fabrication point location 110, and a measurement tool location 112 from a perspective of the tool assembly. As shown, there is a slight offset between the tool fabrication point location 110 and the measurement tool location 112. Also shown in FIG. 1C is an overlay of the points where the measurement tool location 112 would be located in relation to the original toolpath 100, based on the positional offset between the tool fabrication point location 110 and the measurement tool location 112 as placed in the tool head 108. In examples, the tool path could be representative of a 3D printing operation, a laser DED (directed energy deposition) process, a fused deposition modeling (FDM) printer, a machining toolpath, such as a milling operation, and the like, all of which are point-based tools which are both conducted and can be measured using a point-based laser measurement device. Additive manufacturing, subtractive manufacturing, part characterization, part treatment or a combination thereof can be examples of suitable processes which can employ methods and systems of the present disclosure. One rationale for having an offset between a fabrication and measurement tool is the difficult of measuring z-height in a fabrication process with two tools (one working/fabricating and one measuring) in the same location due to physical constraints. For additive processes, the materials deposition takes a certain amount of time to settle or solidify before a measurement can be taken. For example, in a typical molten metal droplet deposition 3D printing process, the molten metal droplet will not solidify until the deposition spot has moved away completely. In general, if the deposition process has a deposition radius R (for example, the droplet spreading radius in a molten metal drop 3D printing process), the offset distance should be greater than R. Therefore, an offset distance or distance between a working tool and a measurement tool is advantageous.

In other examples, low pass filtering of the measurement data can further be employed. For example, in a construction of a fabrication tool, in example one direction of motion may be continuous and another may be discrete motion. The distance of discrete motion can limit or determine resolution in that direction. The measurement device may have increased resolution, and a low pass filter can serve to broaden the coverage of the measurement to cover an average area and not perceive or indicate a drop off or gap in measurement caused by a line spacing or other discrete motion of the fabrication tool. Thus, a low pass filtering operation can “fill in the blanks” of missing measurement information. Typically, the low pass filter is applied to the collected digital data. In the case of a laser distance sensor, this low pass filtration function can be accomplished by broadening the laser spot in a direction perpendicular to the toolpath. In general, the laser spot should have some overlap between two adjacent toolpaths. This spot size modification can be considered an analogue low pass filter.

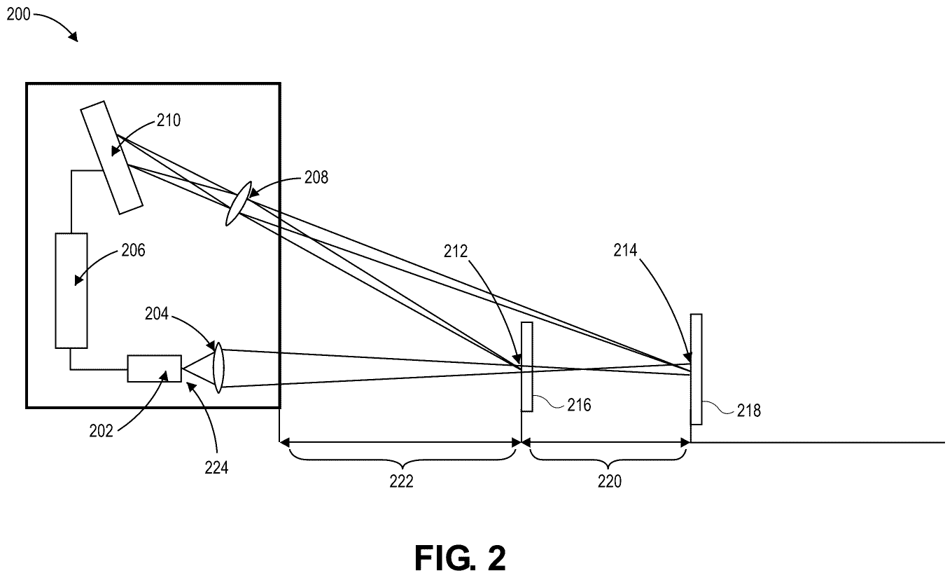

FIG. 2 is a schematic of a laser sensing system, in accordance with the present disclosure. A typical laser sensing system 200 and its operational principles are shown and demonstrated in FIG. 2. A laser supply 202 is shown, connected to a sensor processing unit 206 which can include a power supply, and directing a laser beam 224 at a first lens 204. Also built into the laser sensing system 200 is an additional lens 208 and a sensor 210. The laser beam 224 interacts with a first measurement sample position 212 and a second measurement sample position 214 with an example part at a first position 216. Also shown is the example part at a second position 218. Thus, a working range 220 in x-direction can be determined based on a difference between the first measurement sample position 212 and second measurement sample position 214. Also indicated is a base distance of measurement 222 in an x-direction. This is one example of a laser triangulation system. Typically, the point of focus for a measurement surface is as fine as possible. Due to constraints of a tool head or tool assembly (printhead, FDM head, etc.) it is necessary to measure at an angle, rather than exactly perpendicular to the measurement point of interest, as it would typically be directly under the tool activity work area. Two sample positions are shown, exhibiting the distance to the sensor, and the z-height can be calculated from the angle and the working distance sensed by the return laser beam measurement.

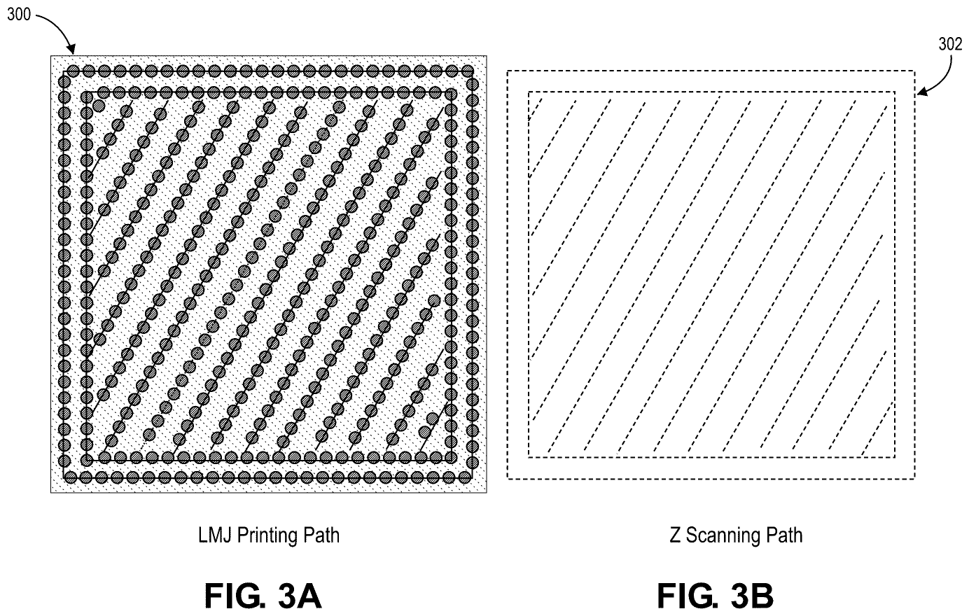

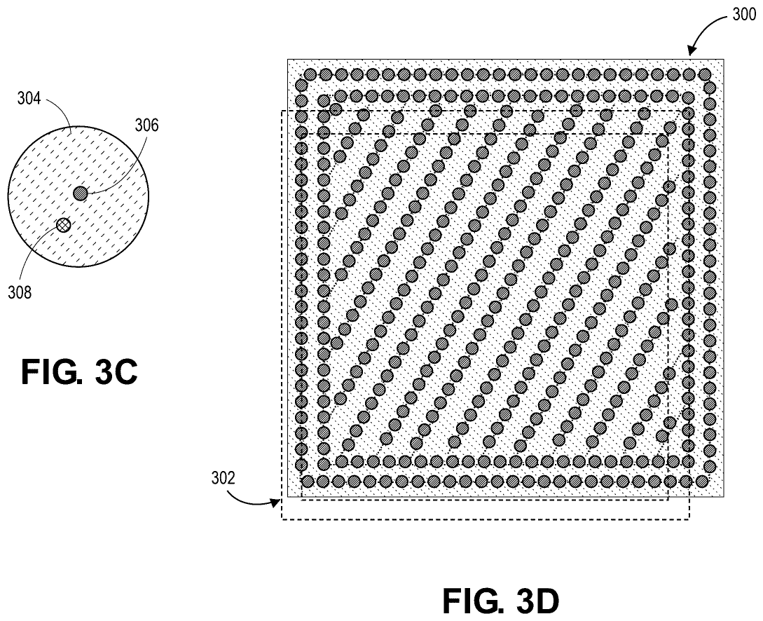

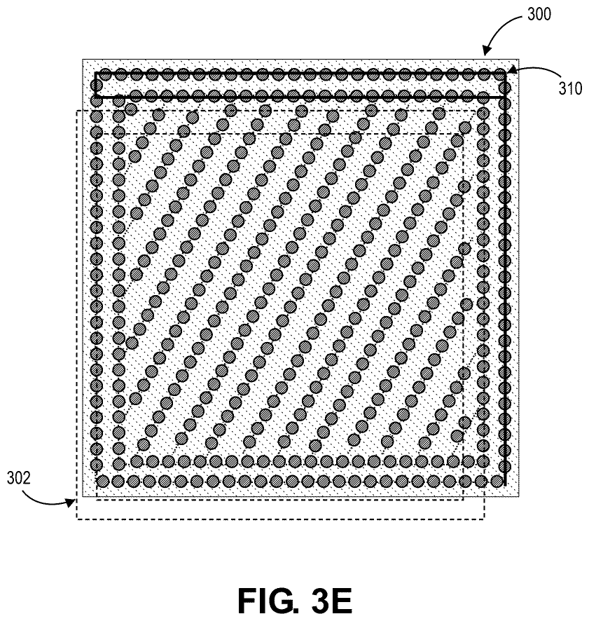

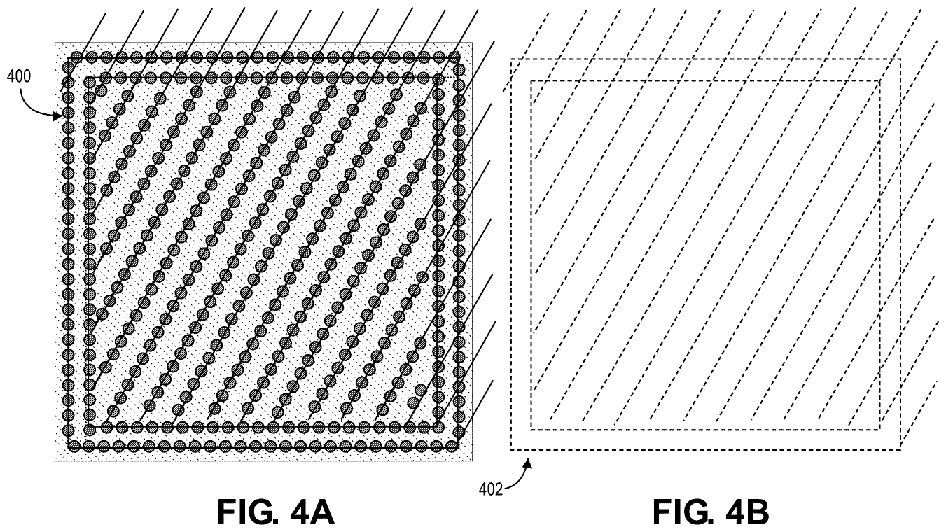

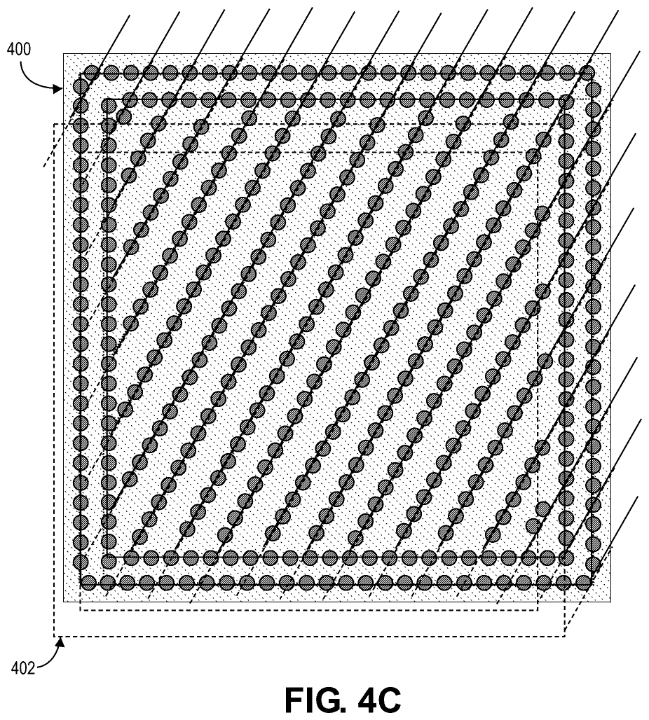

FIGS. 3A-3E is a series of schematics demonstrating a method of measuring the results of a toolpath implementation using a makeup scan path, in accordance with the present disclosure. FIG. 3A is a schematic of a tool path 300 during a fabrication, for example in a liquid metal jetting (LMJ) printing path. The dots or circles represent a tool working point or coordinate, where lines in the tool path 300 represent a path that the tool will follow during execution of the tool working instructions. The tool working instructions can include a machining action, deposition action, and the like. FIG. 3B shows a z-height scanning path 302 which represents a desired location of measurements during the execution of the toolpath 300.

FIG. 3C shows a tool assembly 304 having a tool position 306 and a measuring position 308 within the tool assembly 304 from a top view perspective. Based on the physical offset of the tool position 306 from the measuring position 308, the composite overlay of the tool path 300 and the z-height scanning path 302 shows the resulting offset of the two paths 300, 302 when conducted at the same time and location, as driven by movement of the tool assembly 304. The method and system of the present disclosure executes a makeup scan path 310 in this example to account for portions of the tool path 300 that are not measured during the execution of the complete tool path 300. The makeup scan path is a short, additional or supplementary portion appended to the original z-height scanning path 302. In this example the tool path 300 is followed by the z-height scanning path 302 with an offset makeup scan path 310 during the last portion. This portion of the makeup scan path 310 can be accelerated relative to the speed of the tool path 300 and the z-height scanning path 302 to reduce the amount of time, and therefore cumulative time over the course of an entire part fabrication procedure that will be needed to perform the makeup scan path 310 in this example.

FIGS. 4A-4C is a series of schematics demonstrating a method of measuring the results of a toolpath implementation using an extended toolpath, in accordance with the present disclosure. FIG. 4A shows a schematic of a tool path 400 during a fabrication. Dots or circles represent a tool working point or coordinate, where lines represent a path that the tool can follow during execution of the tool working instructions. The tool working instructions can include a machining action, deposition action, and the like. FIG. 4B shows a z-height scanning path 402 which represents a desired location of measurements during the execution of the toolpath 400.

FIG. 4C shows a composite overlay of the fabrication tool path 400 and the z-height scanning path 402 which is the result of an offset of the two paths 400, 402 when conducted at the same time and location, as driven by movement of a tool assembly, as described previously herein. The method and system of the present disclosure shows that the z-height scanning path 402 can be conducted in this example to account for portions of the tool path 400 that are not measured during the execution of the complete tool path 400, by having an offset arrangement of a working tool and a measurement tool, such that the measurement tool path 402 can be started prior to a tool path 400, and also extended beyond the location of the tool path 400 to capture all points of interest during the measurement. This can be modified or altered by changing the offset position and relative location of a tool position and a measurement position within a tool assembly, and accommodating any offset difference via control systems and/or calculations during measurement interpretations.

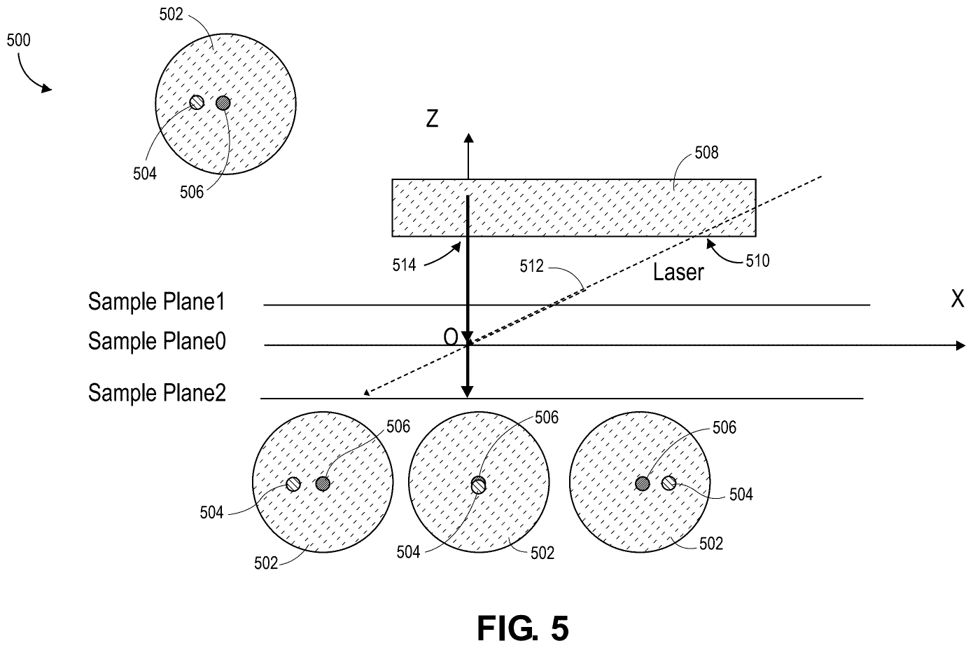

FIG. 5 is a side-view schematic showing a toolpath measurement method using an angled laser measurement device, in accordance with the present disclosure. In the scenario shown in FIG. 5 shows a measurement system 500 schematic with a tool assembly 502 with a movable offset position between a measurement tool position 504 and a fabrication tool position 506. The tool assembly 502 is shown from a top-view perspective. In examples, the tool assembly 502 can have a configuration where the 504 trails the 506, where the measurement tool position 504 and the fabrication tool position 506 have a very small offset position, or where the measurement tool position 504 leads the fabrication tool position 506 during the execution of a fabrication process in an x-direction. A cross-section shows a tool assembly 508 where the measurement position 510 leads the tool position 514 during the execution of a fabrication process in an x-direction. This cross-section further shows where a laser beam 512 intersects a point, indicated by a zero or “0,” at a sample plane 0. The angle of the laser beam relative to a perpendicular line between the tool position 514 and the zero point can be used to calculate the z-height of a surface of the three-dimensional part being fabricated that corresponds to a location of the tool position 514 in lateral (x and y) space. In the example shown in FIG. 5, the incidence angle of the laser is approximately 60 degrees. However, this angle can be adjusted based on the offset position of the laser measurement position relative to the offset distance from the tool position. In examples, the offset tool assembly can be rotated as well. Distance or direction can be altered, depending on the range of laser angle. The range of a laser incidence angle (from vertical) can be from 0 degrees to about 20 degrees, which would be as close to vertical (the incidence angle) as possible, resulting in a shorter offset distance, or from about 20 degrees to about 75 degrees, with larger angles resulting in longer offset distances. In examples, a longer offset distance could be desired, such as in the case of using a high temperature or high velocity rotating tool operation. This would place the measurement tool position further from a fabrication tool position to avoid physical or environmental interference from the operation of the tool. In addition to the methods of adjusting the laser incidence angle or the laser position, FIG. 5 illustrates an alternative method to change the offset position for some tools. For certain tools such as the molten metal drop deposition head, the standoff distance between the tool piece or printing head and the part can be changed within a certain range with little impact on the printing process. For an angled incident laser, the offset position can be adjusted by changing this standoff distance. FIG. 5 illustrates three standoff distances to sample planes 0, 1, and 2, and the corresponding three different offset distances as indicated by the three views on the bottom row: center, right and left.

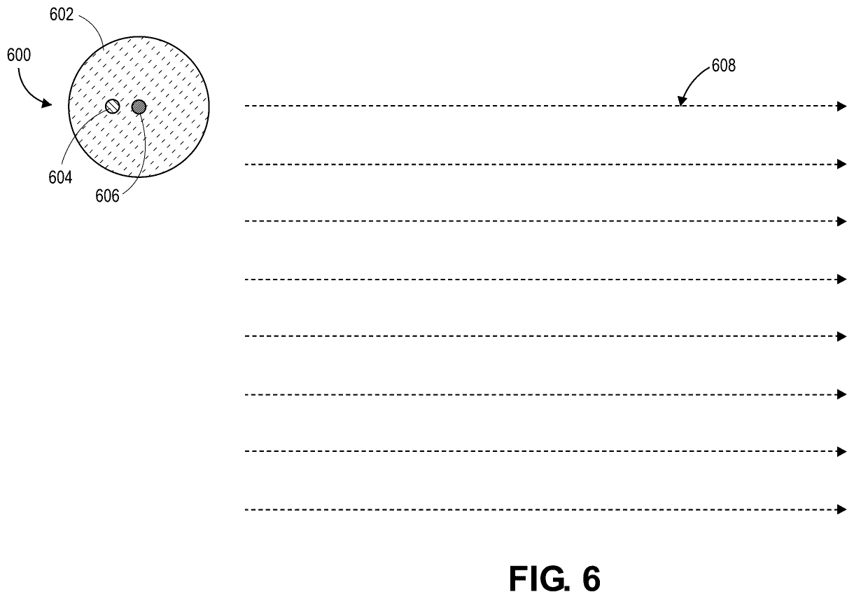

FIG. 6 shows a method of measuring a toolpath with an offset measurement arrangement in a single direction toolpath, in accordance with the present disclosure. In the example shown in FIG. 6, a tooling and measurement system 600 is depicted that measures a discrete line or path after the tooling process. In a schematic of tool assembly 602, a measurement tool position 604 and a fabrication tool position 606 are shown. As a tooling operation or procedure follows a process direction 608, in multiple lines repeated in the same direction as process direction 608, the z-height measurement is obtained after the tooling operation takes place, based on the position of the measurement tool position 604 and fabrication tool position 606 as they proceed in the process direction 608. In an example of a drop on demand liquid metal jetting printing operation or tool, a droplet of printing material would be deposited in a line following the process direction 608, and the line or portion of a layer deposited would be measured a short time after the deposition, based on the depicted orientation of the tool assembly 602. In other examples, the offset of the measurement position can be configured such that the measurement could be taken prior to a deposition step or operation, or both before and after a deposition step or operation. If both before and after deposition measurements are taken, the incorporation of a second measurement position into the tool assembly 602 could be implemented, for example, in a position on either side of the fabrication tool position 606. This could be implemented, in one example, to measure a surface before deposition, after deposition, or both. Likewise, if a subtractive tool operation was being conducted by the fabrication tool, the surface before, after, or both, relative to a subtractive fabrication tool operation could be measured.

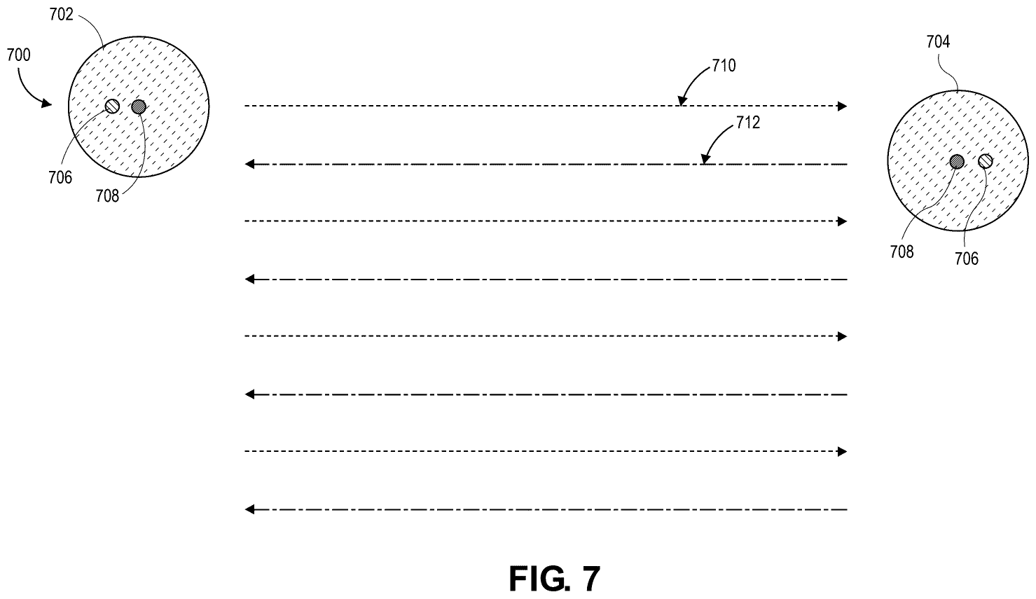

FIG. 7 shows a method of measuring a toolpath with an offset measurement arrangement in a bidirectional toolpath, in accordance with the present disclosure. In the example shown in FIG. 7, a tooling and measurement system 700 is depicted that measures a discrete line or path after the tooling process. In contrast to the measurement shown in FIG. 6, the one depicted in FIG. 7 shows a bi-directional process. In a first orientation of a tool assembly 702 and a second orientation of a tool assembly 704, a measurement tool position 706 and fabrication tool position 708 from a top view are shown. As the tool assembly proceeds in its first orientation of a tool assembly 702 in a first process direction 710, the orientation of the measurement tool position 706 and fabrication tool position 708 are oriented such that as fabrication operations proceed along the first process direction 710, measurement is completed after a short delay of the fabrication operation in the same location that the fabrication operation occurred. As the tool assembly proceeds in its second orientation of a tool assembly 704 in a second process direction 712, the measurement tool position 706 and fabrication tool position 708 are oriented in a 180 degree position relative to the first orientation of a tool assembly 702. As such, as fabrication operations proceed along the second process direction 712, measurement is completed after a short delay of the fabrication operation in the same location that the fabrication operation occurred. This transition from a first orientation of a tool assembly 702 to a second orientation of a tool assembly 704 can be accomplished by rotation of the tool assembly, replacement of the tool assembly, the use of two distinctly different tool assemblies, change the standoff distance as illustrated in FIG. 5, or by other means known to one skilled in the art. In this and other examples where more than one laser measurement sensors would be used in the same environment, it would be useful for the multiple laser measurement sensors to operate at different wavelengths to avoid interference between multiple sensor outputs. In still other examples, alternate wavelength can be used based on the temperature or condition of the three-dimensional part state or build material used. The processes in the first direction and second direction need not be done in succession. In examples, all processes for a specific layer in a first direction can be conducted, followed by all processes in a second direction. Alternatively, the procedures in a first direction or second direction can be interspersed between one another to provide for efficient toolpath management.

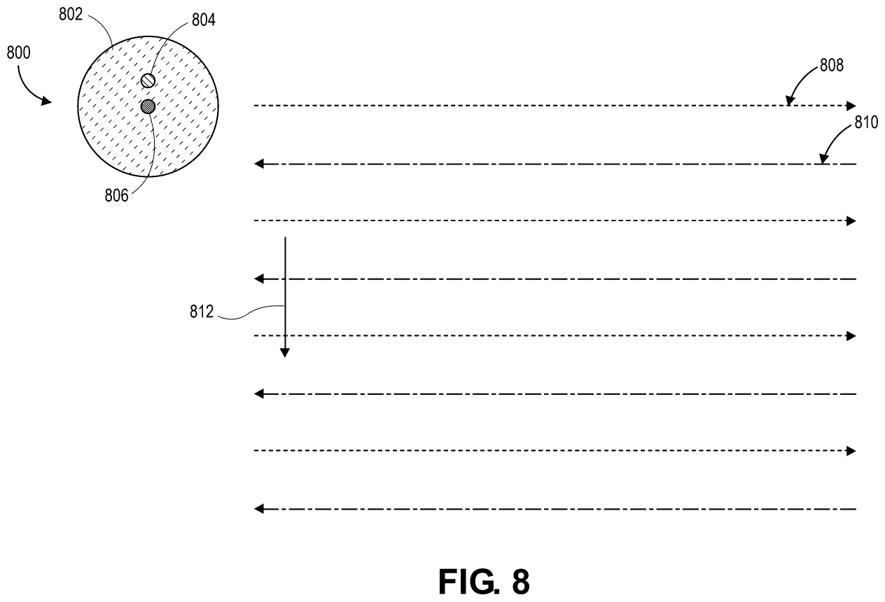

FIG. 8 shows a method of measuring a toolpath with an offset measurement arrangement in a single direction toolpath with sweeping in a second direction, in accordance with the present disclosure. In the example shown in FIG. 8, a tooling and measurement system 800 is depicted showing a tool assembly 802 with a measurement tool position 804 in another orientation relative to the fabrication tool position 806, as shown in top view. This can be referred to as a single direction sweeping measurement. As the tool assembly 802 moves in a fabrication process along one line, there is a sweeping direction 812, which can be implemented in either single direction or bi-directional processing. With this offset orientation, a previously fabricated line 808 can be measured as a subsequent line 810 is fabricated. In examples, the tool assembly 802 can alternately be oriented in a 180-degree position relative to the depicted configuration, where a previous layer, adjacent line could be measured prior to fabrication.

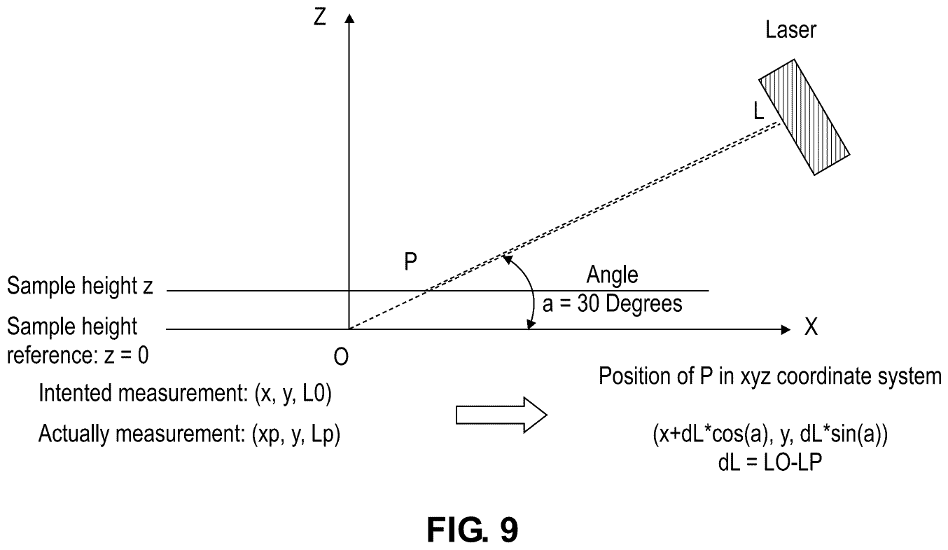

FIG. 9 depicts a series of plots describing a practical arrangement and orientation of a toolpath measurement system and method, in accordance with the present disclosure. FIG. 9 provides additional details on how to measure and correct for possible errors in z and x directions in exemplary fabrication systems. For example, using a 30 degree or more angle, or 40 degrees, 50 degrees, or 60 degrees, the distance to the sensors is actually measured, and not the actual z-height. Using point O as a sample height reference, with a measurement being offset from the tooling spot can, in some examples, require a correction. Typical measurements in fabrication operations are conducted at a tooling spot, or at a deposition spot. Temperature issues, measurement interactions, tooling collision, and other concerns can motivate the use of lasers directed at an offset measurement position, as described herein. This further requires that in certain examples, the laser is delivered at an angle other than normal incidence, or perpendicular to the tooling spot or locus of measurement interest. When the incidence angle of the laser is significantly greater than zero (for example greater than 20 degrees), the sensor reading is quite different from the conventional z height measurement. For example, if the sample is at the intended reference height z=0, the measured spot would have been point O with known XY position of (x, y) from the current location of the translation stage and the measured LO (the distance to the front face of the laser sensor) by the laser. However, if the actual sample deviates from the reference model, for example, the sample is at height z, the actual measurement spot is now point P which will have a different XY position of (xp, y) and a distance to the laser LP. For convenience, in FIG. 9, angle a is chosen to be the angle between the laser and the horizontal axis OX. The common measure of incident angle (from normal direction) is 90−a. Since the laser is delivered at an angle, a, from horizontal OX, in the methods and systems of the present disclosure, not only z is different from the reference O, the x is also changed, as compared to a conventional normal incidence case, only the z is changed. If an intended measurement is at a point designated by (x, y, LO) and an actual measurement is made at a point represented by (xP, y, LP), the position of P in an xyz coordinate system can be equivalent to (x+dL*cos(a), y, dL*sin(a)), where dL=LO−LP=PO. This correction scheme may not be necessary at all angles. This correction scheme can be used at a laser incident angle (from normal direction) greater than 10 degrees, or greater than 20 degrees. Sampling position in x-direction will change with z-height variation. Sampling positions in x-direction cannot be pre-determined and will be irregular. Sampling position will not change in y-direction. Therefore, if sampling is conducted along the y-direction, the irregular samples with irregular sampling intervals in x-direction can be restored to regular sample with simple 1D interpolation.

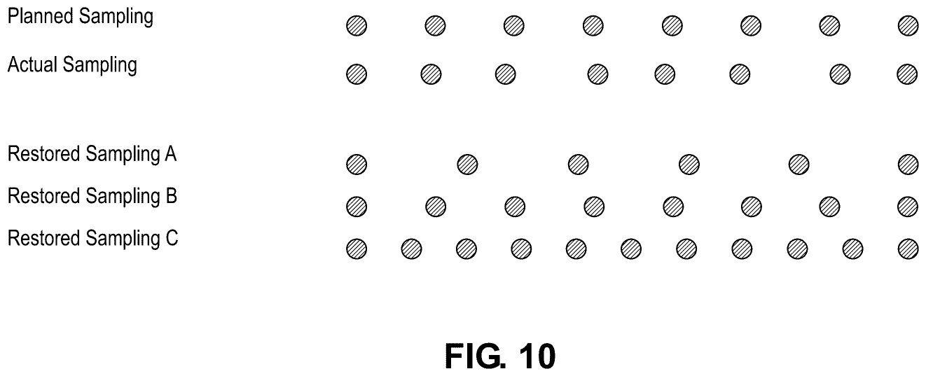

FIG. 10 depicts a diagram of a restored sampling procedure, in accordance with the present disclosure. The example shown is a comparison of a grouping of measurement spots along a horizontal line. Planned sampling is determined based on spot size, spot shape, line spacing and other common toolpath parameter considerations, and relates to the desired frequency of conducting a z-height measurement to monitor the toolpath as it is executed. Actual sampling may or may not be capable of performing in accordance with the planned sampling scenario because of the off-vertical laser incidence, and thus, the spacing is not matching the planned sampling positions across the line. For example, if there is a desire to create a measurement image having uniform x and y spacing, the line spacing of a toolpath defines one resolution, and the scanning along a toolpath line defines another, higher resolution. When constructing a raster image of these different resolutions at a 1:1 aspect ratio, the resampling of the data in the lower resolution, line spacing direction can serve as a basis of resampling the line scanning. If sampling is conducted along a y direction (scan line or toolpath travel along the y direction), the irregular samples with irregular sampling intervals in x can be restored to regular sample with simple 1D interpolation, with choice of sampling intervals and phases, based on the starting position. From the restored regular sampling data, a 2D height image (3D profile) can be easily constructed.

The system for measuring surface heights during three-dimensional fabrication of the present disclosure includes a point z-height sensor configured to measure a position of a tool fabrication spot on a surface being printed. The system also includes an attachment mechanism for attaching the point z-height sensor to a tool assembly such that movement of the point z-height sensor remains in sync with a toolpath may include movement of the tool assembly. The system also includes a control system configured to optimize a scan path of the tool based on measured height data and movement of the tool assembly. Implementations of the system for measuring surface heights during three-dimensional fabrication may include where the tool is a printhead. The point z-height sensor can be a non-contact senser such as a laser triangulation sensor, optical imaging sensor, ultrasonic distance sensor, induction or capacitance-based distance sensor. In some applications, a contact senser can be used, such as a stylus or contact profilometer. The laser triangulation sensor can be configured at a non-normal incidence angle. The system may include a control loop for compensating for any z-height errors during a fabrication process based on the measured height data. An attachment mechanism or tool assembly is configured to maintain an offset distance between the tool fabrication spot and a z-height sensor measurement spot. The system for measuring surface heights during three-dimensional fabrication can include a dynamic adjustment mechanism for changing a position of the z-height sensor measurement spot relative to the tool fabrication spot. The point z-height sensor and the additional point z-height sensor can be arranged in a grid pattern perpendicular to the toolpath for increasing x-y resolution. After the data is correctly restored to the (x, y, z) coordination, it is compared to the intended input digital model. If the error is greater than a pre-determined threshold, a corrective action can be initiated. The corrective action can include any system control methods or manipulation of the toolpath or both to compensate for the height errors through mass density (mass per unit area) adjustments. The system may include a low-pass filter for smoothing out any noise in the measured height data. Typically, the low pass filter is applied to the collected digital data. This spot size modification can be considered an analogue low pass filter. In the case of a laser triangulation senser, this low pass filter can imply the manipulation (broadening) of the laser spot profile in at least one direction such that it is broader enough to cover the space between two adjacent toolpaths. This spot size modification can be considered an analogue low pass filter.

A method for measuring z-height during three-dimensional fabrication using a z-height point sensor includes moving a z-height point sensor attached to a tool assembly in synchronization with a toolpath may include tool assembly movement to follow a measurement scanning path. The method also includes measuring a position of a fabrication spot with the z-height point sensor using laser triangulation. The method also includes determining an offset distance between the fabrication spot and a measurement spot of the z-height point sensor. The method also includes producing a combined tool-scan-path by co-optimizing the toolpath and measurement scanning path to simulate a condition where the offset is non-zero. The method also includes generating a three-dimensional profile by scanning a top surface of a fabricated layer. Implementations of the method for measuring z-height during three-dimensional fabrication using a z-height point sensor may include adjusting the offset distance between the fabrication spot and a measurement spot of the z-height point sensor of the point z-height sensor. The method may include scanning with an additional z-height point sensor to increase scanning resolution. The additional z-height point sensor can be configured to scan in a direction perpendicular to the toolpath. The method may include filtering data from the point z-height sensor with a low-pass filter. The method may include adjusting the offset position of the point z-height sensor during a fabrication operation. The point z-height sensor is mounted on a movable platform configured to be adjusted to compensate for variations in a fabrication process. The deviations can be identified by comparing the generated three-dimensional profile with a reference profile stored in memory. For example, the measured information can be compared with an intended toolpath stored as a reference profile to determine or assess variations in the fabrication process when executed.

The present disclosure is directed to a method for measuring surface height in a three-dimensional printing process. The method for measuring surface height in a three-dimensional printing process includes measuring the height and position of an ejected drop of printing material as it lands on a substrate or portion of a three-dimensional part using a point z-height sensor after the drop of printing material is ejected from an ejector nozzle. The method also includes moving a position of the point z-height sensor in synchronicity with movement of the ejector nozzle. The method also includes adjusting an offset position between the point z-height sensor and the ejector nozzle based on variations of a measured position as compared to a reference position. The method also includes generating a three-dimensional profile by scanning a top surface of a printed layer with the point z-height sensor. Implementations of the method for measuring surface height in a three-dimensional printing process may include attaching the point z-height sensor to a printhead assembly, and following a toolpath used for part building by the ejector nozzle with the z-height scanning path. The method may include filtering data from the point z-height sensor with a low-pass filter.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A system for measuring surface heights during three-dimensional fabrication, comprising:
a point z-height sensor configured to measure a position of a tool fabrication spot on a surface being printed;
an attachment mechanism for attaching the point z-height sensor to a tool assembly such that movement of the point z-height sensor remains in sync with a toolpath comprising movement of the tool assembly; and
a control system configured to optimize a scan path of the tool based on measured height data and movement of the tool assembly.

2. The system of claim 1, wherein the tool is a printhead.

3. The system of claim 1, wherein the point z-height sensor is a laser triangulation sensor.

4. The system of claim 3, wherein the laser triangulation sensor is configured at a non-normal incidence angle.

5. The system of claim 1, further comprising a control loop for compensating for any z-height errors during a fabrication process based on the measured height data.

6. The system of claim 1, wherein the attachment mechanism is configured to maintain an offset distance between the tool fabrication spot and a z-height sensor measurement spot.

7. The system of claim 1, further comprising an additional point z-height sensor, wherein the point z-height sensor and the additional point z-height sensor are arranged in a grid pattern perpendicular to the toolpath for increasing X-Y resolution.

8. The system of claim 6, further comprising a dynamic adjustment mechanism for changing a position of the z-height sensor measurement spot relative to the tool fabrication spot.

9. The system of claim 1, further comprising a low-pass filter for smoothing out any noise in the measured height data.

10. A method for measuring z-height during three-dimensional fabrication using a z-height point sensor, comprising:
moving a z-height point sensor attached to a tool assembly in synchronization with a toolpath comprising tool assembly movement to follow a measurement scanning path;
measuring a position of a fabrication spot with the z-height point sensor using laser triangulation;
determining an offset distance between the fabrication spot and a measurement spot of the z-height point sensor;
producing a combined tool-scan-path by co-optimizing the toolpath and measurement scanning path to simulate a condition where the offset is non-zero; and
generating a three-dimensional profile by scanning a top surface of a fabricated layer.

11. The method of claim 10, further comprising adjusting the offset distance between the fabrication spot and a measurement spot of the z-height point sensor of the point z-height sensor.

12. The method of claim 10, further comprising scanning with an additional z-height point sensor to increase scanning resolution.

13. The method of claim 12, wherein the additional z-height point sensor scans in a direction perpendicular to the toolpath.

14. The method of claim 10, further comprising filtering data from the point z-height sensor with a low-pass filter.

15. The method of claim 10, further comprising adjusting the offset position of the point z-height sensor during a fabrication operation.

16. The method of claim 10, wherein the point z-height sensor is mounted on a movable platform configured to be adjusted to compensate for variations in a fabrication process.

17. The method of claim 10, further comprising identifying and correcting any deviations from an intended toolpath or scan path using the generated three-dimensional profile, wherein the deviations can be identified by comparing the generated three-dimensional profile with a reference profile stored in memory.

18. A method for measuring surface height in a three-dimensional printing process, comprising:
measuring the height and position of an ejected drop of printing material as it lands on a substrate or portion of a three-dimensional part using a point z-height sensor after the drop of printing material is ejected from an ejector nozzle;
moving a position of the point z-height sensor in synchronicity with movement of the ejector nozzle;
adjusting an offset position between the point z-height sensor and the ejector nozzle based on variations of a measured position as compared to a reference position; and
generating a three-dimensional profile by scanning a top surface of a printed layer with the point z-height sensor.

19. The method of claim 18, further comprising:
attaching the point z-height sensor to a printhead assembly; and
following a toolpath used for part building by the ejector nozzle with the z-height scanning path.

20. The method of claim 18, further comprising filtering data from the point z-height sensor with a low-pass filter.
